(19) United States
(12) Patent Application Publication
(10) Pub. No.: US 2024/0063588 A1
(43) Pub. Date: Feb. 22, 2024

(54) ERROR PROOFING SYSTEM FOR ASSEMBLED SQUIB DEVICES

(71) Applicant: Toyota Motor Engineering & Manufacturing North America, Inc., Plano, TX (US)

(72) Inventors: Jamar L. Elzie, Pontotoc, MS (US); Jacob R. Fish, Pontotoc, MS (US); Leigh M. Higby, Semmes, AL (US); Lincoln T. Whittington, Fort Branch, IN (US)

(73) Assignees: Toyota Motor Engineering & Manufacturing North America, Inc., Plano, TX (US); Toyota Jidosha Kabushiki Kaisha, Aichi-ken (JP)

(21) Appl. No.: 17/890,753

(22) Filed: Aug. 18, 2022

(51) Int. Cl. H01R 13/703; H01R 13/645; H01R 13/66

(52) U.S. Cl. CPC H01R 13/7039; H01R 13/6456; H01R 13/6691

(57) ABSTRACT

Embodiments herein are directed to an error proofing system that determines whether an assembled squib device is properly assembled is provided. The assembled squib device has a connector seated within a canister. The error proofing system includes an electronic control unit and an electrical device. The electrical device includes a body and a head portion. The body includes a wireless transmitter. The head portion includes three micro-switches electrically coupled to the wireless transmitter and is shaped and sized to receive a portion of the connector of the assembled squib device to make contact between the connector and at least one of the three micro-switches and to make contact with an uppermost surface of the canister such that a different two micro-switches of the three micro-switches make contact with the uppermost surface when the connector is properly installed within the canister to form the assembled squib device.

### TECHNICAL FIELD

The present disclosure generally relates to error proofing devices and, more specifically, to error proofing devices that detect a proper assembly of sub components.

### BACKGROUND

Many vehicles today include air bag assemblies. The assembly includes an inflatable canister located in the steering column, the passenger-side dashboard, the side door panel, or seat. When a particular rate of deceleration is detected, the canister is inflated by an explosive device, known as a squib, which contains an explosive material. The explosive material is electronically actuated when a signal is transmitted thereto over a transmission medium (e.g., wires). The wires are attached to the squib via a squib connector which plugs into the squib socket. During assembly, an assembler installs the squib connector into the squib socket of the canister. It is common for an assembler to incorrectly install the squib connector into the squib socket of the canister or forget altogether to install the squib connector into the squib socket of the canister.

### SUMMARY

In one aspect, an error proofing system is provided. The error proofing system includes an electronic control unit and an electrical device. The electrical device includes a body having a wireless transmitter electrically coupled to the electronic control unit and a head portion. The head portion has micro-switches electrically coupled to the wireless transmitter such that an electrical signal is transmitted from a power supply to the wireless transmitter when each of the micro-switches are moved from an initial open position into a closed position. Each of the micro-switches are independently movable by contact with components of an assembled squib device when appropriately aligned.

These and additional objects and advantages provided by the embodiments described herein will be more fully understood in view of the following detailed description, in conjunction with the drawings.

### BRIEF DESCRIPTION OF THE DRAWINGS

The embodiments set forth in the drawings are illustrative and exemplary in nature and not intended to limit the subject matter defined by the claims. The following detailed description of the illustrative embodiments can be understood when read in conjunction with the following drawings, where like structure is indicated with like reference numerals and in which:

FIG. 1A schematically depicts a perspective view of an error proofing system that includes a first aspect of an electrical device according to one or more embodiments shown or described herein;

FIG. 1B schematically depicts a partially exploded view of the error proofing system of FIG. 1A with a second aspect of an electrical device and head portions according to one or more embodiments shown or described herein;

FIG. 2 schematically depicts a circuit schematic of the error proofing system of FIG. 1A according to one or more embodiments shown or described herein; and

FIG. 3 schematically illustrates example assembled squib devices with a connector seated in various positions within a canister and example head portions of the error proofing system of FIG. 1A detecting whether the example assembled squib devices are properly assembled according to one or more embodiments shown and described herein.

### DETAILED DESCRIPTION

Vehicles according to the present disclosure include an airbag assembly. For the airbag assembly to inflate, a squib connector is used to fire a squib positioned within an inflatable canister to inflate the canister when a particular rate of deceleration is detected. During installation in a manufacturing facility, there is a possibility for an operator to incorrectly install the squib connector into the inflatable canister. As such, embodiments disclosed herein are directed to an error proofing system to confirm that the squib connector is seated within the canister. The error proofing system includes an electronic control unit and an electrical device. The electrical device has a body with a wireless transmitter electrically coupled to the electronic control unit and a head portion releasably coupled to the body. The head portion has three micro-switches arranged in a series configuration and electrically coupled to the wireless transmitter. The head is shaped and sized to receive a portion of the squib connector to make electrical contact between the squib connector and at least one of the three micro-switches and to make contact with an uppermost portion of the canister to make electrical contact between the canister and a different two micro-switches of the three micro-switches when installed onto the properly assembled squib device.

When the assembled squib device is not installed properly, at least one of the three micro-switches will not make contact with either or both of the squib connector and the canister. As such an electrical signal generated by a power source positioned within the head portion will not be transmitted beyond the at least one of the three micro-switches that is not making contact with either or both of the squib connector and the canister. When the assembled squib device is installed properly, the electrical signal is transmitted through each of the three micro-switches and is wirelessly transmitted from the wireless transmitter to the electronic control unit. As such, the electrical signal received by the electrical control unit is indicative of a properly assembled squib device.

As used herein, the term “electrically coupled” means that coupled components are capable of exchanging data signals and/or electric signals (e.g., current, voltage, and/or the like) with one another such as, for example, electrical signals via conductive medium, electromagnetic signals via air, optical signals via optical waveguides, electrical energy via conductive medium or a non-conductive medium, data signals wirelessly and/or via conductive medium or a non-conductive medium and the like.

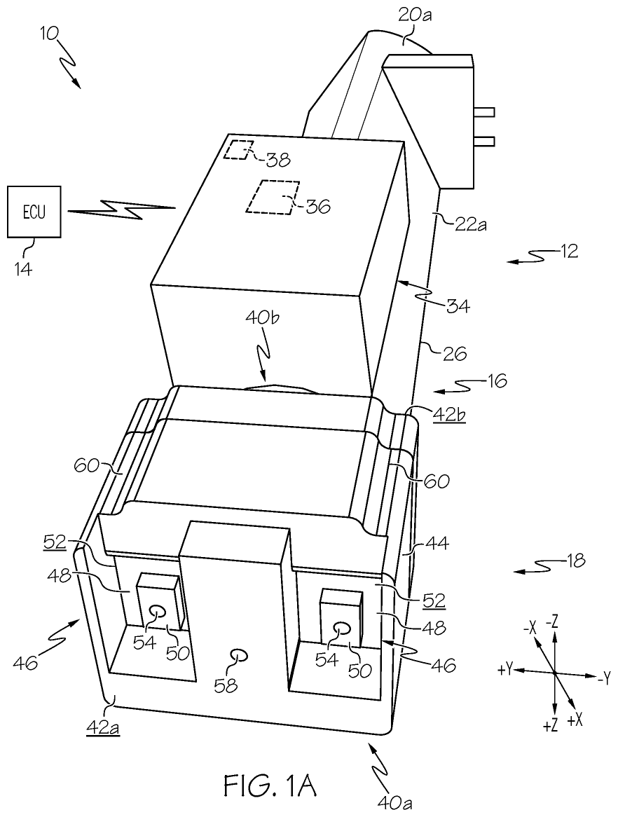

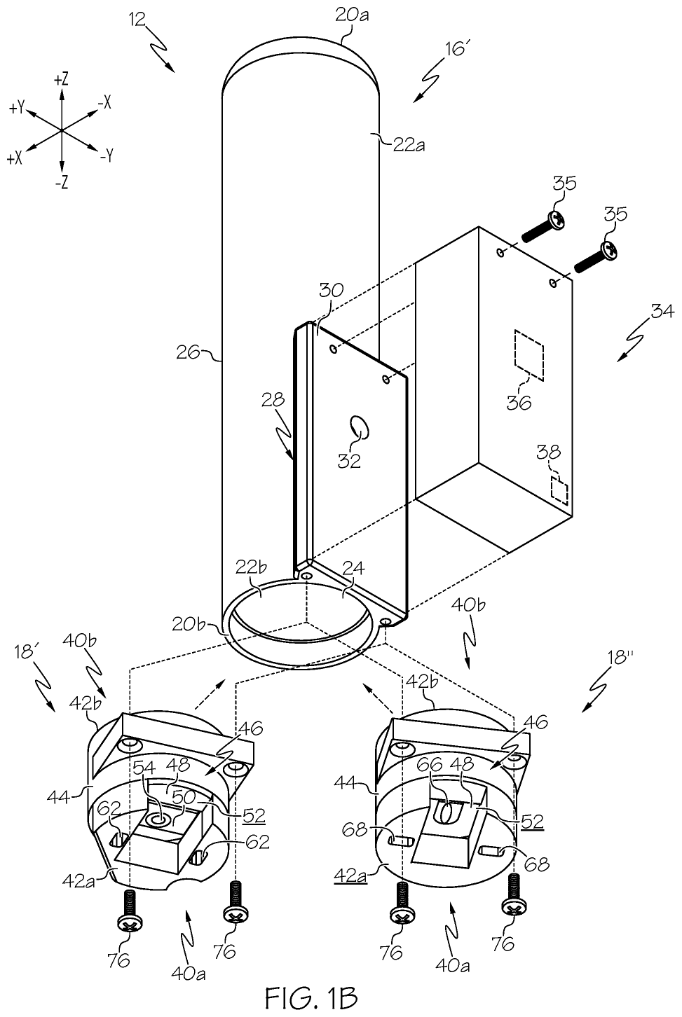

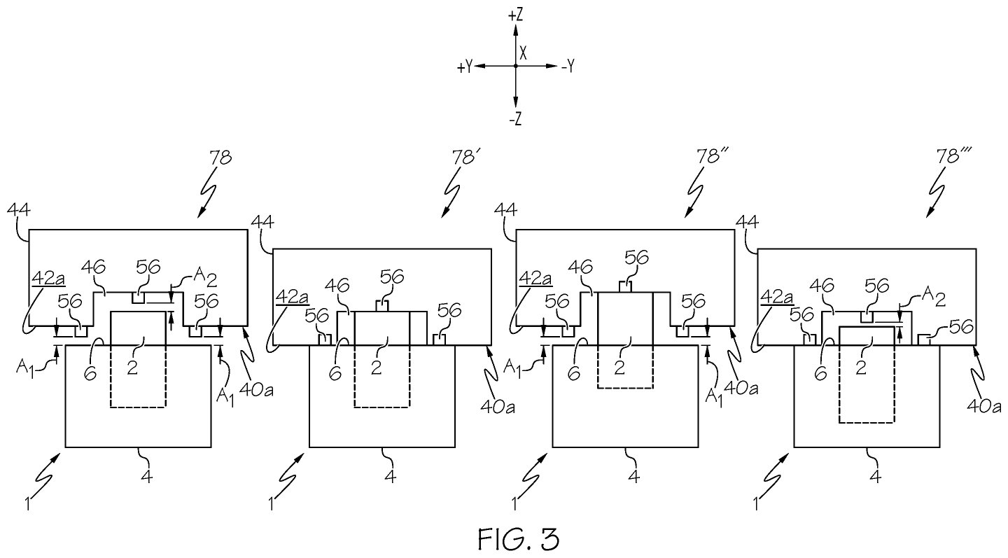

Further, as used herein, the term “longitudinal direction” refers to the forward-rearward direction of the electrical device (i.e., in the +/−X-direction depicted in the coordinate axes of FIGS. 1A-1B and 3). The term “lateral direction” refers to the cross-electrical device direction (i.e., in the +/−Y-direction depicted in the coordinate axes of FIGS. 1A-1B and 3), and is transverse to the longitudinal direction. The term “vertical direction” or “below” or “above” refer to the upward-downward direction of the electrical device (i.e., in the +/−vehicle Z-direction depicted in the coordinate axes of FIGS. 1A-1B and 3).

Referring now to FIGS. 1A-1B and 2-3, an error proofing system 10 (e.g. a pokayoke system) is schematically depicted. The error proofing system 10 as described herein determines whether an assembled squib device 1 (FIG. 3) is properly assembled. The assembled squib device 1 includes a connector 2 that is seated within a canister 4. As such, as discussed in greater detail herein, the error proofing system 10 detects when the connector 2 is not properly seated within the canister 4.

The error proofing system 10, as depicted in FIG. 1A, includes an electrical device 12 and an electronic control unit 14 electrically coupled to the electrical device 12. The electrical device 12 includes a body 16 and a head portion 18. It should be appreciated that the electrical device 12 of FIG. 1A and the electrical device 12 of FIG. 1B are similar with exception of the body 16 and the head portion 18 are each differently shaped. As such, like features will use the same reference numerals and the various differing aspects will use prime symbols to designate between the different body 16 and/or head portion 18 when needed.

The body 16 extends between a distal end 20a and an opposite receiving end 20b, as best illustrated in FIG. 1B. The body 16 further includes an outer surface 22a and an opposite inner surface 22b extending between the distal end 20a and an opposite receiving end 20b. The receiving end 20b may include a cavity 24. In some embodiments, the cavity 24 extends from the receiving end 20b terminating at the distal end 20a. In other embodiments, the cavity 24 extends from the receiving end 20b and terminates somewhere between the receiving end 20b and the distal end 20a.

In some embodiments, the receiving end 20b and/or the cavity 24 may be circular in shape, as best depicted in FIG. 1B. In other embodiments, the receiving end 20b and/or the cavity 24 may be any shape, such as square, rectangular, hexagonal, and/or the like. In some embodiments, the body 16 may be a cylindrical in shape, as best illustrated in FIG. 1B. In other embodiments, the body 16 may be triangular, as best illustrated in FIG. 1A. It should be understood that these shapes of the body 16 are non-limiting and the shape of the body 16 may be square, hexagonal, octagonal, irregularly shaped, and/or the like. In embodiments, portions of the body 16 may be used as a handle 26 by an operator to hold and maneuver the electrical device 12 to perform the functionality of the electrical device 12, as described in greater detail herein.

A mounting member 28 extends from the outer surface 22a of the body 16. In some embodiments, the mounting member 28 is a plate that includes an exterior surface 30. In other embodiments, the mounting member 28 may be unsitrut, round stock, and/or the like. In some embodiments the mounting member 28 is integrally formed with the body 16. That is, the mounting member 28 and the body 16 are a monolithic structure. In other embodiments, the mounting member 28 is a separate structure that is coupled to the body 16 via at least one fastener, such as a nut and bolt, screw, rivet, adhesive, epoxy, and/or the like. The mounting member 28 defines an aperture 32 that provides access to the cavity 24. The aperture 32 provides access for electrical components, such as electrical wires, to travel between the cavity 24 and the mounting member 28.

The body 16 may be formed using injection molding techniques and/or additively manufacturing. In some embodiments, the body 16 may be formed from a nylon material. In other embodiments, the body 16 may be formed from a plastic material such as a polymer, a polyetheretherketone (PEEK), and the like. In other embodiments, the body 16 may be formed from materials suitable for injection molding or additive manufacturing such as Acrylonitrile Butadiene Styrene (ABS), Polyethylene (PE), Polyamide (Nylon), High Impact Polystyrene (HIPS), Polypropylene (PP), and the like. In other embodiments, the body 16 may be a steel, a composite metal, ceramic, concrete, resin, or any other suitable material that may be in solid, liquid, powder, sheet material, wire, or any other suitable form.

As used herein, the term “additively manufactured” refer generally to manufacturing processes wherein successive layers of material(s) are provided on each other to “build-up,” layer-by-layer, a three-dimensional component. The successive layers generally fuse together to form a monolithic component which may have a variety of integral sub-components. Although additive manufacturing technology is described herein as enabling fabrication of complex objects by building objects point-by-point, layer-by-layer, typically in a vertical direction, other methods of fabrication are possible and within the scope of the present subject matter. For example, although the discussion herein refers to the addition of material to form successive layers, one skilled in the art will appreciate that the methods and structures disclosed herein may be practiced with any additive manufacturing technique or manufacturing technology. For example, embodiments of the present invention may use layer-additive processes, layer-subtractive processes, or hybrid processes.

A wireless transmitter 34 may be coupled to the exterior surface 30 of the mounting member 28 via at least one fastener 35, such as a nut and bolt, screw, rivet, and/or the like. The wireless transmitter 34 is electrically coupled to the electronic control unit 14 to wirelessly transmit signals from the electrical device 12 to the electronic control unit 14. In some embodiments, the wireless transmitter 34 may include a built in LED display 36 to communicate a go/no-go condition to the operator. Further, the wireless transmitter 34 may include a power source 38 that independently provides power to the transmitter. In some embodiment the power source 38 may be a battery. In other embodiments, the power source 38 may be a corded application such as 110V, 220V, and/or the like. Further, as discussed in greater detail herein, the wireless transmitter 34 may be electrically coupled to components of the head portion 18.

The head portion 18 includes an outer surface 42a and spaced apart opposite inner surface 42b. A continuous wall 44 separates or spaces the outer surface 42a from the inner surface 42b such that a cavity is formed between the outer surface 42a the inner surface 42b and between portions of the continuous wall 44. The head portion 18 further includes an engagement portion 40a and an opposite coupling portion 40b. In some embodiments, the coupling portion 40b includes the inner surface 42b and may include a portion of the continuous wall 44, as discussed in greater detail herein. For example, in the embodiment of FIG. 1A, the coupling portion 40b extends from the inner surface 42b and is positioned below the continuous wall 44 of the head portion 18 in the vertical direction (i.e., in the +/−Z direction of the coordinate axes of FIG. 1A). In the embodiment of FIG. 1B, the coupling portion 40b of the head portion 18′ or 18″ includes the inner surface 42b and a portion of the continuous wall 44. As such, at least a portion of the coupling portion 40b is received within the cavity 24.

The coupling portion 40b may shaped to compliment the shape of the receiving end 20b such that the coupling portion 40b is received by the receiving end 20b. For example, in both FIGS. 1A-1B, the coupling portion 40b is illustrated as cylindrical. This is non-limiting, and the coupling portion 40b may be any shape, such as square, triangular, octagonal, hexagonal, and/or the like. Such an arrangement permits for interchangeability of the head portion 18, 18′, 18″, and others. That is, the head portion 18 is releasably coupled to the body 16, as best illustrated in FIG. 1A and the head portion 18′, 18″ are each releasably coupled to the body 16′. Further, this is non-limiting as the head portion 18 may be coupled to the body 16′ and/or the head portion 18′, 18″ may be coupled to the body 16. In some embodiments, at least one fastener 76, such as a nut and bolt, screw, rivet, and/or the like, couples the head portion 18 to the body 16 and/or couples the head portion 18′, 18″ to the body 16′. As such, a plurality of differently sized and shaped head portions may be utilized to correspond or compliment the size and shape of the connector 2 and canister 4 of the assembled squib device 1.

Referring now back to FIG. 1A, the continuous wall 44 is generally square in shape. In some embodiments, a pair of arcuate portions 60 extend between the inner surface 42b and the engagement portion 40a in the vertical direction (i.e., in the +/−Z direction). The engagement portion 40a of the head portion 18 includes a pair of spaced apart recessed channels 46. The pair of recessed channels 46 are each positioned below a portion of the outer surface 42a in the vertical direction (i.e., in the +/−Z direction) and extend partially into the continuous wall 44 in the lateral direction (i.e., in the +/−Y direction). In some embodiments, each of the pair of recessed channels 46 are rectangular shaped and include a floor 48 and a multi-step portion 50 extending from a floor surface 52 of the floor 48 in the vertical direction (i.e., in the +/−Z direction). In other embodiments, each of the pair of recessed channels 46 may be other shapes such as elliptical, circular, square, and/or the like. The floor 48 of each of the pair of recessed channels 46 opens into the continuous wall 44 below the outer surface 42a in the vertical direction (i.e., in the +/−Z direction).

Each of the pair of recessed channels 46 include an aperture 54 positioned within the multi-step portion 50. In some embodiments, the aperture 54 positioned within the multi-step portion 50 of each of the pair of recessed channels 46 is centered within the multi-step portion 50. In other embodiments, the aperture 54 positioned within the multi-step portion 50 of each of the pair of recessed channels 46 is offset from the center point, or not centered, within the multi-step portion 50. Each aperture 54 is configured to receive a micro-switch 56 of the head portion 18, as discussed in greater detail herein. A third aperture 58 is positioned within the engagement portion 40a extending through the outer surface 42a of the head portion 18. As such, the third aperture 58 is positioned above the aperture 54 positioned within the multi-step portion 50 of each of the pair of recessed channels 46 in the vertical direction (i.e., in the +/−Z direction). The third aperture 58 is configured to receive a micro-switch 56 of the head portion 18, as discussed in greater detail herein.

Referring now back to FIG. 1B, the continuous wall 44 of the head portion 18′, 18″ is generally cylindrical in shape. The engagement portion 40a of the head portion 18′, 18″ includes a single recessed channel 46. The recessed channel 46 is positioned below a portion of the outer surface 42a in the vertical direction (i.e., in the +/−Z direction) and extends partially into the continuous wall 44 in the longitudinal direction (i.e., in the +/−X direction of the coordinate axes of FIG. 1B). The recessed channel 46 may be rectangular shaped and includes the floor 48 and the multi-step portion 50 extending from the floor surface 52 of the floor 48 in the vertical direction (i.e., in the +/−Z direction). In other embodiments, the recessed channel 46 may be other shapes such as elliptical, circular, square, and/or the like. The floor 48 opens into the continuous wall 44 below the outer surface 42a in the vertical direction (i.e., in the +/−Z direction).

The recessed channel 46 of the head portion 18′ includes the aperture 54 positioned within the multi-step portion 50. In some embodiments, the aperture 54 positioned within the multi-step portion 50 is centered within the multi-step portion 50. In other embodiments, the aperture 54 positioned within the multi-step portion 50 is offset from the center point, or not centered, within the multi-step portion 50. The aperture 54 is configured to receive the micro-switch 56 of the head portion 18, as discussed in greater detail herein. A pair of elongated slots 62 are positioned within the engagement portion 40a extending through the outer surface 42a of the head portion 18′. As such, the pair of elongated slots 62 are positioned above the aperture 54 positioned within the multi-step portion 50 of the recessed channel 46 in the vertical direction (i.e., in the +/−Z direction). The pair of elongated slots 62 extend in the longitudinal direction (i.e., in the +/−X direction). Each of the pair of elongated slots 62 are configured to receive the micro-switch 56 of the head portion 18′, as discussed in greater detail herein.

The engagement portion 40a of the head portion 18″ includes the single recessed channel 46. The recessed channel 46 is positioned below a portion of the outer surface 42a in the vertical direction (i.e., in the +/−Z direction) and extends partially into the continuous wall 44 in the lateral direction (i.e., in the +/−Y direction of the coordinate axes of FIG. 1B). The recessed channel 46 may be rectangular shaped and include the floor 48. In other embodiments, the recessed channel 46 may be other shapes such as elliptical, circular, square, and/or the like. The floor 48 opens into the continuous wall 44 below the outer surface 42a in the vertical direction (i.e., in the +/−Z direction).

The recessed channel 46 includes an elongated slot 66 positioned to extend through the floor surface 52. In some embodiments, the elongated slot 66 is centered within the recessed channel 46 in both the lateral (i.e., in the +/−Y direction) and the longitudinal direction (i.e., in the +/−X direction). In other embodiments, the elongated slot 66 is offset from the center point, or not centered, in either the lateral (i.e., in the +/−Y direction) and/or the longitudinal direction (i.e., in the +/−X direction). The elongated slot 66 extends in the longitudinal direction (i.e., in the +/−X direction). The elongated slot 66 is configured to receive the micro-switch 56 of the head portion 18, as discussed in greater detail herein.

A pair of elongated slots 68 are positioned within the engagement portion 40a extending through the outer surface 42a of the head portion 18″. As such, the pair of elongated slots 68 are positioned above the elongated slot 66 positioned within the recessed channel 46 in the vertical direction (i.e., in the +/−Z direction). Each of the pair of elongated slots 68 extend in the lateral direction (i.e., in the +/−Y direction). Further, each of the pair of elongated slots 68 are configured to receive the micro-switch 56 of the head portion 18″, as discussed in greater detail herein.

The head portion 18, 18′, 18″ may be formed using injection molding techniques and/or additively manufacturing. In some embodiments, the head portion 18, 18′, 18″ may be formed from a nylon material. In other embodiments, the head portion 18, 18′, 18″ may be formed from a plastic material such as a polymer, a polyetheretherketone (PEEK), and the like. In other embodiments, the body 16 may be formed from materials suitable for injection molding or additive manufacturing such as ABS, PE, Nylon, HIPS, PP, and the like. In other embodiments, the head portion 18 may be a steel, a composite metal, ceramic, concrete, resin, or any other suitable material that may be in solid, liquid, powder, sheet material, wire, or any other suitable form.

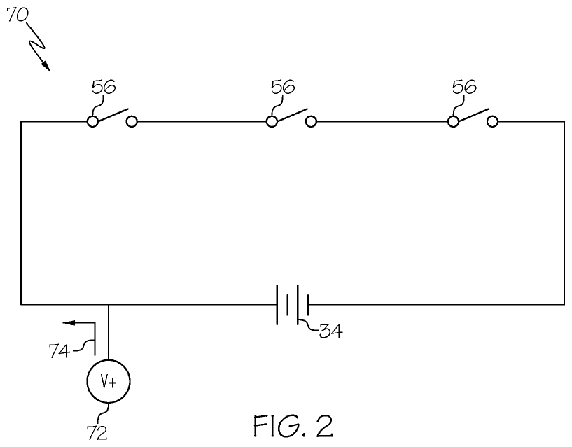

Now referring to FIG. 2, a circuit 70 is schematically depicted. The circuit 70 includes the micro-switches 56, a power supply 72, and the wireless transmitter 34 arranged in a series configuration. The power supply 72 is positioned before the micro-switches 56 and the wireless transmitter 34 is positioned after the micro-switches 56. It should be understood that each of the micro-switches 56 are formed with a conductive material such that when a structure makes contact with the respective micro-switch 56, the micro-switch 56 moves within the head portion 18 (e.g., within each aperture 54, 58 of the head portion 18, or within each of the aperture 54 and the pair of elongated slots 62 of the head portion 18′, or within the elongated slot 66 and the pair of elongated slots 68 of the head portion 18″) to make contact with electrical components within the cavity of the head portion 18, such as the circuit 70, to electrically change from a normally open position, as illustrated in FIG. 2, into a closed position. The closed position permits an electrical signal 74 to pass through the micro-switch 56. In other embodiments, the movement from the normally open position into the closed position may occur when the micro-switches 56 make contact with an external conductive material, such as a conductive material that makes contact with the engagement portion 40a of the head portion 18.

As illustrated, there may be three micro-switches 56, one for each aperture 54, 58 of the head portion 18, or one for the aperture 54 and one for each elongated slot of the pair of elongated slots 62 of the head portion 18′, or one for each of the elongated slot 66 and the pair of elongated slots 68 of the head portion 18″. As such, because of the series arrangement, the electrical signal 74, generated by the power supply 72, must pass through each of the three micro-switches 56 before the electrical signal 74 is received by the wireless transmitter 34, which in turn transmits the electrical signal 74 to the electronic control unit 14 (FIG. 1A). As such, for the electrical signal 74 to be transmitted from the power supply 72 to the wireless transmitter 34, each of the three micro-switches 56 must be in the closed position. As the closed position for the micro-switch 56 may only occur when each of the three micro-switches 56 are in contact with a structure to move the respective micro-switch 56 into the closed position, the micro-switches 56 and the series arrangement form the error proofing or pokayoke, requiring all three micro-switches be in the closed position for the electrical signal 74 to pass through them.

Now referring to FIG. 3, example assembled squib devices 1 with the connector 2 seated in various positions within the canister 4 are schematically depicted. Further, example head portions 78, 78′, 78″, 78′″ positioned onto the example assembled squib devices 1 to determine whether the assembled squib devices 1 is properly assembled are schematically depicted. It should be understood that the example head portions 78, 78′, 78″, 78′″ may be the head portion 18, the head portion 18′, the head portion 18″, or another configuration of the head portion.

The head portion 78 is configured to be positioned onto the assembled squib device 1. The recessed channel 46 of the engagement portion 40a receives at least a portion of the connector 2 and the outer surface 42a makes contact with an uppermost surface 6 of the canister 4. As illustrated with respect to the head portion 78, none of the micro-switches 56 have been moved from the normally open position into the closed position. That is, there is a gap between each respective micro-switches 56 and the connector 2 and the uppermost surface 6 of the canister 4 represented by arrows A1 and A2, respectively.

That is, the recessed channel 46 receives a portion of the connector 2 extending beyond the uppermost surface 6 of the canister 4 in the vertical direction (i.e., in the +/−Z direction). As such, the micro-switch 56 extending within the aperture or elongated slot of the recessed channel 46 of the head portion 78 is not making contact with the connector 2 resulting in a gap or space, depicted by arrow A2. This results in the micro-switch 56 positioned in the recessed channel 46 remaining in the normally open position. Further, the micro-switches 56 extending from the outer surface 42a within the apertures or elongated slots of the head portion 78 are both not making contact with the uppermost surface 6 or surface of the canister 4 resulting in a gap or space, depicted by arrow A1. This results in the micro-switches 56 positioned to extend through the outer surface 42a remaining in the normally open position. As such, because the micro-switches 56 of the head portion 78 would not be moved into the normally closed position, the electrical signal 74 (FIG. 2) would not be transmitted to the wireless transmitter 34 (FIG. 2) resulting in a fail or no-go condition for this particular assembled squib devices 1 not properly assembled.

The head portion 78′ illustrates a condition where the micro-switch 56 extending within the aperture or elongated slot of the recessed channel 46 of the head portion 78 is making contact with the connector 2 and the micro-switches 56 extending from the outer surface 42a within the apertures or elongated slots of the head portion 78 are both making contact with the uppermost surface 6 of the canister 4. As such, all three of the micro-switches 56 are in the normally closed position resulting in the electrical signal 74 (FIG. 2) being transmitted to the wireless transmitter 34 (FIG. 2) and, in turn, the wireless transmitter 34 (FIG. 2) transmitting the electrical signal 74 to the electronic control unit 14 indicating a pass or go condition for this particular assembled squib devices 1 being properly assembled.

The head portion 78″ illustrates a condition where the micro-switch 56 extending within the aperture or elongated slot of the recessed channel 46 of the head portion 78 is making contact with the connector 2. As such, the micro-switch 56 positioned in the recessed channel 46 is now in the closed position. However, the micro-switches 56 extending from the outer surface 42a within the apertures or elongated slots of the head portion 78 are both not making contact with the uppermost surface 6 of the canister 4 resulting in a gap or space, depicted by arrow A1. As such, the connector 2 is not fully seated within the canister 4 resulting in the micro-switches 56 positioned to extend through the outer surface 42a remaining in the normally open position. In this configuration, the electrical signal 74 (FIG. 2) would not be transmitted to the wireless transmitter 34 (FIG. 2) resulting in a fail or no-go condition for this particular assembled squib devices 1 not properly assembled.

The head portion 78′″ illustrates a condition where the micro-switches 56 extending from the outer surface 42a within the apertures or elongated slots of the head portion 78 are both making contact with the uppermost surface 6 of the canister 4 but the micro-switch 56 extending within the aperture or elongated slot of the recessed channel 46 of the head portion 78 is not making contact with the connector 2. As such, the micro-switch 56 positioned in the recessed channel 46 remains in the normally open position, as indicted by the arrow A2 depicting the gap from the connector 2 and the micro-switch 56. As such, in this condition, the connector 2 is not seated properly within the canister 4 resulting in the micro-switch 56 positioned within the recessed channel 46 to remain in the normally open position. In this configuration, the electrical signal 74 (FIG. 2) would not be transmitted to the wireless transmitter 34 (FIG. 2) resulting in a fail or no-go condition for this particular assembled squib devices 1 not properly assembled.

It should be appreciated that the failure of the wireless transmitter 34 (FIG. 2) to transmit the electrical signal 74 (FIG. 2) to the electronic control unit 14 (FIG. 1A) may result in a line stop action. That is, the electronic control unit (FIG. 1A) may be electrically coupled to other processors that control movement of an assembly line and the failure of the electrical signal 74 (FIG. 2) transmitted to the electronic control unit 14 (FIG. 1A) may result in the electronic control unit 14 (FIG. 1A) communicating a line stop command to the other processors that control movement of the assembly line to stop the assembly line from movement until the electrical signal 74 (FIG. 2) is received by the electronic control unit 14 (FIG. 1A).

It should now be understood that the present disclosure is directed to an error proofing system to confirm that the squib connector is seated within the canister. The error proofing system uses a head portion that includes three micro-switches arranged in a series configuration to make electrical contact between the squib connector and to make contact with an uppermost portion of the canister such that the switches are moved from a normally open position into a closed positon, thereby allowing an electrical signal to pass through each of the switches to a transmitter that transmit a signal wirelessly as an indication that the squib connector is properly seated within the canister.

While particular embodiments have been illustrated and described herein, it should be understood that various other changes and modifications may be made without departing from the spirit and scope of the claimed subject matter. Moreover, although various aspects of the claimed subject matter have been described herein, such aspects need not be utilized in combination. It is therefore intended that the appended claims cover all such changes and modifications that are within the scope of the claimed subject matter.

What is claimed is:

1. An error proofing system, comprising:
an electronic control unit;
an electrical device comprising:
a body having a wireless transmitter electrically coupled to the electronic control unit; and
a head portion having micro-switches electrically coupled to the wireless transmitter such that an electrical signal is transmitted from a power supply to the wireless transmitter when each of the micro-switches are moved from an initial open position into a closed position, each of the micro-switches are independently movable by contact with components of an assembled squib device when appropriately aligned.

2. The error proofing system of claim 1, wherein the assembled squib device includes a connector seated within a canister.

3. The error proofing system of claim 2, wherein the head portion is shaped and sized to receive a portion of the connector of the assembled squib device to make contact between the connector and at least one of the micro-switches.

4. The error proofing system of claim 3, wherein the head portion is shaped and sized to receive to make contact with an uppermost surface of the canister of the assembled squib device such that a different two micro-switches make contact with the uppermost surface only when the connector is properly installed within the canister to form the assembled squib device.

5. The error proofing system of claim 4, wherein the head portion further includes an engagement portion and an opposite coupling portion that is releasably coupled to the head portion to the body.

6. The error proofing system of claim 5, wherein the engagement portion includes at least two spaced apart recessed channels, each of the at least two spaced apart recessed channels receive at least a portion of the connector, and at least a portion of the engagement portion makes contact with the uppermost surface of the canister.

7. The error proofing system of claim 6, wherein each of the at least two spaced apart recessed channels include a multi-step feature.

8. The error proofing system of claim 7, wherein each of the multi-step features of the engagement portion include a first aperture and the engagement portion includes a second aperture.

9. The error proofing system of claim 8, wherein the micro-switches are three micro-switches, two micro-switches extend through and move within the first aperture of each of the multi-step features and a different micro-switch extends through and moves within the second aperture.

10. The error proofing system of claim 5, wherein the engagement portion includes a recessed channel to receive at least a portion of the connector and a portion of the engagement portion makes contact with the uppermost surface of the canister.

11. The error proofing system of claim 10, wherein the recessed channel includes a first slot and an outer surface of the head portion includes a pair of slots positioned on each side of the recessed channel, the first slot and the pair of slots extend in perpendicular directions.

12. The error proofing system of claim 11, wherein the micro-switches are three micro-switches, one of the three micro-switches extend through and move within the first slot and the other two of the three micro-switches extends through and moves within the pair of slots.

13. The error proofing system of claim 10, wherein the recessed channel includes a slot and an outer surface of the head portion includes a pair of slots positioned on each side of the recessed channel.

14. The error proofing system of claim 13, wherein the micro-switches are three micro-switches, two of the three micro-switches extend through and move within the respective pair of slots and the other one of the three micro-switches extends through and moves within the slot.

15. The error proofing system of claim 1, wherein the head portion is releasably coupled to the body.
